(19) United States
(12) Patent Application Publication
(10) Pub. No.: US 2022/0366323 A1
(43) Pub. Date: Nov. 17, 2022

(54) INTELLIGENT SYSTEM FOR PERSONALIZED WORKSPACE EVOLUTION

(71) Applicant: INTERNATIONAL BUSINESS MACHINES CORPORATION, ARMONK, NY (US)

(72) Inventors: Indervir Singh Banipal, Austin, TX (US); Shikhar Kwatra, San Jose, CA (US); Hemant Kumar Sivaswamy, Pune (IN); Clement Decrop, Arlington, VA (US)

(21) Appl. No.: 17/317,198

(22) Filed: May 11, 2021

(51) Int. Cl. G06Q 10/02; G06N 3/08; H04W 12/64

(52) U.S. Cl. CPC G06Q 10/02; G06N 3/08; H04W 12/64

(57) ABSTRACT

A computer that generates a profile of a user based on user preferences, where the user preferences related to an optimal geolocation for the user within a workspace. The computer monitors biometric conditions of the user and environmental conditions of the workspace. The computer categorizes a plurality of areas of the workspace based on the environmental conditions and determines the optimal geolocation for the user by identifying an area within the plurality of areas based on the user preferences and the biometric conditions.

### BACKGROUND

The present invention relates, generally, to the field of computing, and more particularly to workspace geolocation management.

Working environments are, typically, arranged in a way where each worker is assigned a fixed workplace. Recently, flexible shared workspaces are gaining popularity where workers are assigned temporary workstations. Temporary workstations, alternatively called mobile workstations, are employee working environments that enable fast adaptation and configuration of the equipment and provide necessary services for different employees that currently occupy the mobile workstation. For example, the mobile workstation may include a chair, a laptop docking station for connecting the laptop, multiple monitors, a keyboard, a tracking device, an internet connection and a fax or phone that enable easy connection and personalization of the equipment for the time the user occupies the mobile workstation.

Another type of workspace arrangement is an agile workspace. Agile workplaces are spaces designed for maximum flexibility. These workplaces empower employees to work how, where, and when they choose, and gives each employee all of the technology and tools they need. In agile workplaces, the majority of employees don't have assigned desks, and some teams may be seated in designated clusters of workstations. Generally, workers are encouraged to choose whatever setting best suits the activity they are doing at any given time.

### SUMMARY

According to one embodiment, a method, computer system, and computer program product for personalized workspace management is provided. The present invention may include a computer that generates a profile of a user based on user preferences, where the user preferences related to an optimal geolocation for the user within a workspace. The computer monitors biometric conditions of the user and environmental conditions of the workspace. The computer categorizes a plurality of areas of the workspace based on the environmental conditions and determines the optimal geolocation for the user by identifying an area within the plurality of areas based on the user preferences and the biometric conditions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a personalized workspace management process according to at least one embodiment;

FIG. 3 is a block diagram of internal and external components of computers, mobile devices and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to workspace geolocation management. The following described exemplary embodiments provide a system, method, and program product to, among other things, to monitor environmental conditions of the working space using various sensors and biometric values of a user in order to assign an optimal workspace among the available workspaces in the office. Therefore, the present embodiment has the capacity to improve the technical field of matching workspace geolocation according to user preferences and biometrics through improved accuracy of optimal workspace location prediction.

As previously described, working environments are, typically, arranged in a way where each worker is assigned a fixed workplace. Recently, flexible shared workspaces are gaining popularity where workers are assigned temporary workstations. Temporary workstations, alternatively called mobile workstations, are employee working environments that enable fast adaptation and configuration of the equipment and provide necessary services for different employees that currently occupy the mobile workstation. For example, the mobile workstation may include a chair, a laptop docking station for connecting the laptop, multiple monitors, a keyboard, a tracking device, an internet connection and a fax or phone that enable easy connection and personalization of the equipment for the time the user occupies the mobile workstation.

Despite striving to maintain average environmental conditions to satisfy each employee, many office workers are easily distracted, uncomfortable, or unsatisfied from their workstation location. For example, despite air conditioning and lights designed to have a constant temperature and even light distribution, working next to a window may provide more light or cold during the winter season. Furthermore, some people are more effective at work when they are located closer to a person that is more senior and/or experienced. Additionally, if a person is sick, or his biometric values, such as body temperature, shows an elevated reading and thus may be sick, assigning a work place that reduces the risk of transmission of infection may be crucial. As such, it may be advantageous to, for example, monitor user biometrics and environmental factors and, based on the monitoring, determine an appropriate workspace location for the user.

According to one embodiment, a machine learning method may generate a profile for each opted-in user based on past user preferences and, after monitoring biometric values using a wearable device and environmental conditions using available sensors or cameras, determine and assign dynamically an optimal workspace location or area to the user in order to make the user feel more comfortable and thus increase user productivity. In at least one embodiment, the determined workspace may decrease a risk of disease transferability in case the user is sick or have abnormal biometric readings but is still capable of and willing to provide effective work product in an office space.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine and assign an optimal workspace to a user based on biometric readings and office environmental conditions using a reinforcement driven engine.

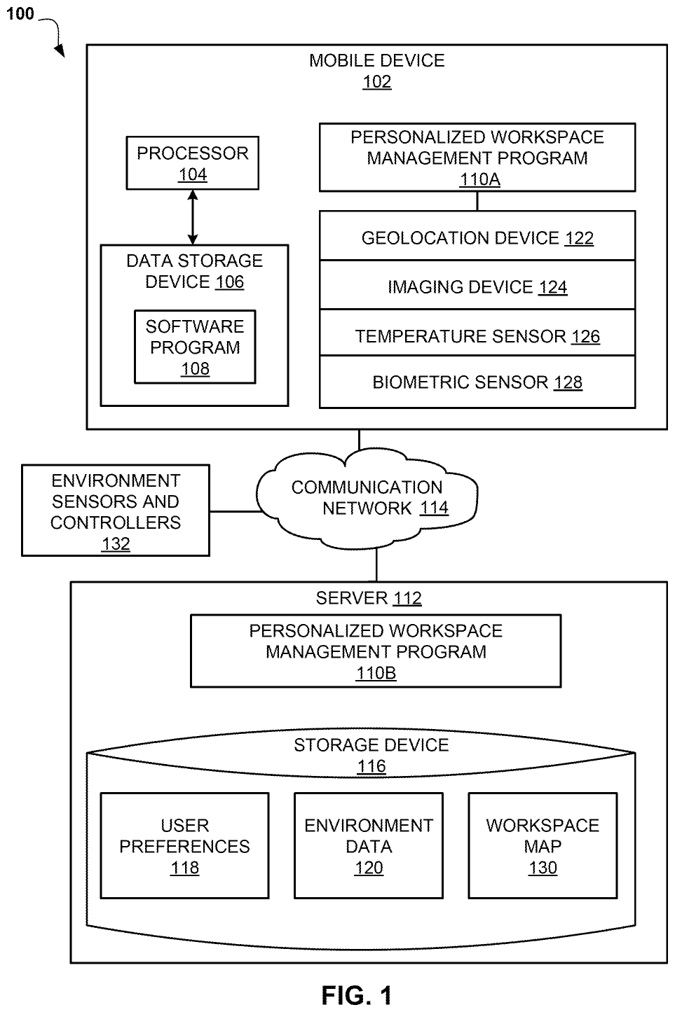

Referring to FIG. 1, an exemplary networked computer environment 100 is depicted, according to at least one embodiment. The networked computer environment 100 may include mobile device 102, environment sensors and controllers 132, and a server 112 interconnected via a communication network 114. According to at least one implementation, the networked computer environment 100 may include a plurality of mobile devices 102 and servers 112, of which only one of each is shown for illustrative brevity. Additionally, in one or more embodiments, the mobile device 102 and a server 112 may each individually host a personalized workspace management program 110A, 110B. In one or more other embodiments, the personalized workspace management program 110A, 110B may be partially hosted on both mobile device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

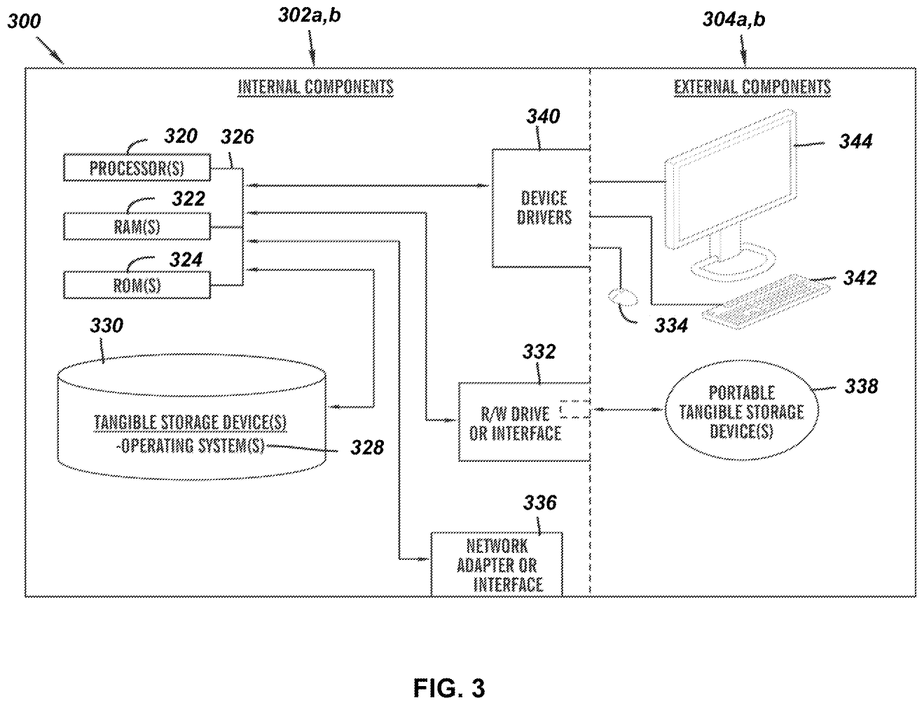

Mobile device 102 may include a processor 104, geolocation device 122, imaging device 124, temperature sensor 126, biometric sensor 128 and a data storage device 106 that is enabled to host and run a software program 108 and a personalized workspace management program 110A and communicate with the server 112 via the communication network 114, in accordance with one embodiment of the invention. Mobile device 102 may be, for example, a wearable device (e.g., a smart watch, cosine ear monitor, whoop arm band, luminosity sensor), a telephone, a personal digital assistant, a netbook, a laptop computer, a tablet computer, a desktop computer, or any type of computing device capable of running a program and accessing a network. As will be discussed with reference to FIG. 3, the mobile device 102 may include internal components 302a and external components 304a, respectively.

The geolocation device 122 may be any positioning system device, such as a Global Positioning System (GPS) receiver, a triangulation device or software capable of determining a location of the mobile device 102 using available Wi-Fi or Bluetooth antennas. In another embodiment, the geolocation device 122 may be a lidar sensor capable of measuring distances from walls or other users and thus determining the geolocation. Imaging device 122 may be a camera or other device capable of taking photographs or capturing a video of the user or the user surroundings. Temperature sensor 126 may be a device capable of measuring a body temperature of the user or the surrounding of the user. Biometric sensor 128 may be any sensor capable of measuring user physical or behavioral characteristics, such as heart rate, oxidation, humidity, breathing rate, glucose levels in blood, etc.

The server computer 112 may be a laptop computer, netbook computer, personal computer (PC), a desktop computer, or any programmable electronic device or any network of programmable electronic devices capable of hosting and running a personalized workspace management program 110B and a storage device 116 and communicating with the mobile device 102, and environment sensors and controllers 132 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The storage device 116 may store and allow access to user preferences 118, environment data 120, and workspace map 130. According to an example embodiment, user preferences 118 may be a database that stores preferences of each user such as a preferred temperature, humidity and light settings, one or more health conditions of the user, whether the user prefers to sit next to other employees or places, time frames when the user arrives and leaves, and other specific environmental requirements preconfigured by the user. The environment data 120 may be a database that stores all of the information received from the environment sensors and controllers 132, such as temperature, humidity, and a geolocation of each measure based on the workspace map 130. The workspace map 130 may be a combination of a map of the workspace area with a database that stores all of the geolocations of each of the workstations available for users in a working environment, an exact location of each of the environment sensors and controllers 132, a seating map of users including unoccupied workspaces, and may include windows locations, rooms, conference rooms, enclosed areas, restrooms, kitchens, and other physical objects or locations that may affect a working environment of the user.

The environment sensors and controllers 132 may be sensors, IoT sensors, or smart cameras to measure the environment parameters in the workspace, such as temperature, noise levels, light and humidity and are capable of transmitting the measures via communication network 114 to server 112. In another embodiment, the environment sensors and controllers 132 may be smart cameras coupled with image processing or artificial intelligence capabilities that may determine temperature based on the infrared spectrum or analyze the images and determine type of clothes the occupants are wearing that may infer whether the occupants are comfortable or may be not feeling well. The environment sensors and controllers 132 may incorporate cameras or other devices to identify free and occupied workspace locations in the workspace and send a notification to the server 112 in order to update seating map of users in the workspace map 130. The controllers of the environment and sensor controllers 132 may be air conditioning, humidity and lightning controllers that control the environment in the workspace and may be controlled and accessed by the server 112 via communication network 114.

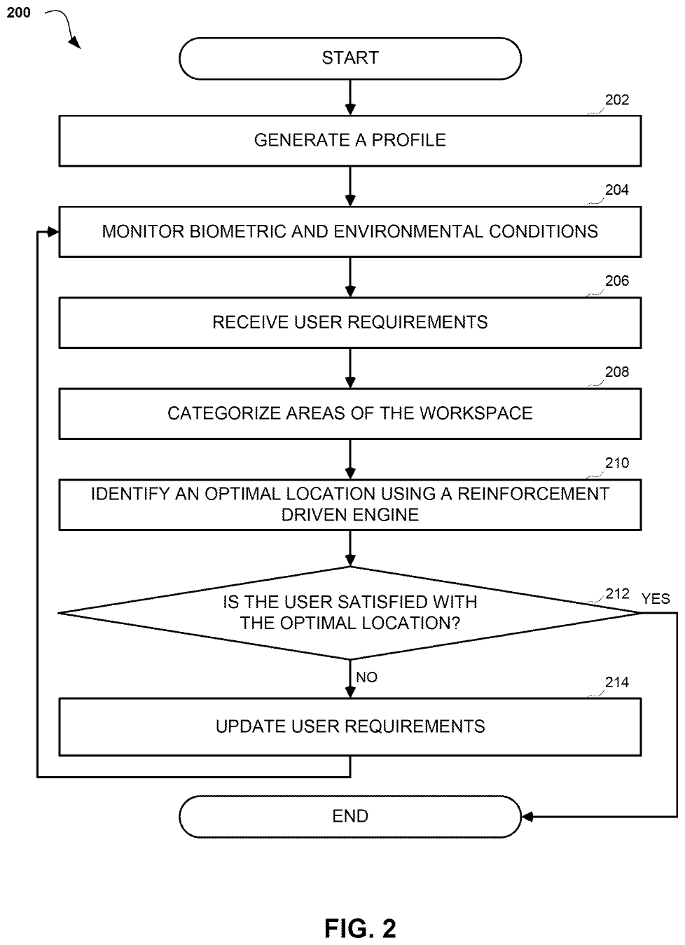

According to the present embodiment, the personalized workspace management (PWM) program 110A, 110B may be a program capable of identifying user preferences, monitoring the workspace environment and user biometric readings and, using all of the above, determining an optimal workspace geolocation for a user to achieve maximum user satisfaction. In at least one embodiment, the PWM program 110A, 110B may be capable of preventing, or reducing the likelihood of, infection transmission when user biometrics readings are abnormal through the relocation of a user to a workspace more conducive to preventing infection transmission. The personalized workspace management method is explained in further detail below with respect to FIG. 2.

Referring now to FIG. 2, an operational flowchart illustrating a personalized workspace management process 200 is depicted according to at least one embodiment. At 202, the PWM program 110A, 110B generates a profile. According to an example embodiment, the PWM program 110A, 110B may request a user to opt in for the service and may request the user fill out a questionnaire in order to generate a user profile and store it in user preferences 118. For example, the PWM program 110A, 110B may request a user using a graphical user interface (GUI) to enter data related to user allergies, climate requirements the user prefers including temperature, humidity and light intensity, identify the coworkers the user prefers to be located nearby, whether the person prefers to work next to a window or alone, and how frequent the user wants to change his location in order to stay focused. In another embodiment, the PWM program 110A, 110B may request the user to enter arriving and leaving hours, geolocation, user title, and organizational division in order for the PWM program 110A, 110B to search for a workspace in the proximity of other employees within the division. In a further embodiment, PWM program 110A, 110B may access geolocation device 122 and determine user preferred geolocations at the workspace within a predetermined timeframe threshold and set the area the user was located at as the user preferred working area. In further embodiments, the PWM program 110A, 110B may access user emails and messages to determine other coworkers that the user frequently interacts with in order to update the priorities of the user to be located close to the determined other coworkers. In additional embodiments, the PWM program 110A, 110B may access user profiles on one or more social networks to determine other coworkers the user interacts with and when the user arrives and leaves the workplace.

Next, at 204, the PWM program 110A, 110B monitors biometric and environmental conditions. According to an example embodiment, the PWM program 110A, 110B may monitor and update temperatures, humidity and light intensity in various locations of the working environment using environment sensors and controllers 132, temperature sensor 126, and biometric sensor 128. In addition, the PWM program 110A, 110B may update the environment data 120 database based on the received readings from the sensors. In another embodiment, the PWM program 110A, 110B may analyze photographs of the user and determine whether the user is heavily or lightly dressed in order to determine whether to recommend an area within workspace that is warmer or colder based on the apparel worn by the user.

Then, at 206, the PWM program 110A, 110B receives user requirements. According to an example embodiment, the PWM program 110A, 110B may use a GUI on the mobile device 102 and ask a user to fill a questionnaire related to preferred temperature, light and/or humidity. In another embodiment, the PWM program 110A, 110B may access a user profile and determine user requirements based on previous preferences or previous geolocations within the workspace. For example, the PWM program 110A, 110B may access an email of the user and determine a time when the user comes to the office and leaves it based on the first and last email sent by the user from the email account. In addition, the PWM program 110A, 110B may determine the frequency of communications of the user with other coworkers and automatically set that the user prefers to be located next to the determined coworkers. In another embodiment, the PWM program 110A, 110B may determine user body temperature using the temperature sensor 126 or environment and controllers 132 and if the body temperature of the user is above a predetermined threshold value set that the user would like to be located in a private closed environment or in a closed and independently ventilated space so that the user with abnormal temperature would not spread of possible infection. In another embodiment, the PWM program 110A, 110B may present using GUI a questionnaire that is related to user's physical and mental condition, such as whether the user has headache, cough, runny nose or other symptoms that will show signs of possible infection, and, therefore, better to place the user in an isolated workspace.

Then, at 208, the PWM program 110A, 110B categorizes areas of the workspace. According to an example embodiment, the PWM program 110A, 110B may categorize office locations based on the temperature range and humidity. In addition, the PWM program 110A, 110B may identify secluded or distant areas for accommodation of the users having an abnormal body temperature readings or users that stated that they have cold symptoms. In another embodiment, the PWM program 110A, 110B may categorize office locations based on the light, noise, windows, rank or positions in the organization and other environmental or personal conditions or preferences important to the users. According to an example embodiment, the PWM program 110A, 110B may apply a K-Means algorithm to the available readings from the sensors to cluster the available spaces or areas based on the environment data 120 and user preferences 118. According to an example embodiment, the PWM program 110A, 110B may update the workspace map 130 according to the determined clusters and further update the clusters by applying the K Nearest Neighbor approach when no unoccupied workspaces are available to match the user preferences to the available workstation.

Next, at 210, the PWM program 110A, 110B identifies an optimal location using a reinforcement driven engine. According to an example embodiment, the PWM program 110A, 110 may identify a workspace for the user as an area within the categorized areas from step 208 that most closely aligned with the user preferences and the monitored biometric readings. According to an example embodiment, the PWM program 110A, 110B may identify the area using a reinforcement engine that assigns to each customer a plurality of reward parameters that are increased when the user gives positive feedback or decreased when the user gives negative feedback. The feedback may be determined using a GUI or by inferring from the actions of the user, such as changing location or removing clothes. In another embodiment, the PWM program 110A, 110B may identify an optimal location using a trained neural network that receives user requirements, biometric readings and environmental conditions, such as vectors, and, by identifying available spaces from the workspace map 130, assigns an optimal location to the user. According to an example embodiment, the trained neural network may be trained using a set of positive examples when the user was satisfied with the proposed workspace geolocation and a set of negative examples where the user was not satisfied with the proposed geolocation. In another embodiment, the PWM program 110A, 110B may utilize a regression prediction model to identify the optimal location. The regression prediction model may identify the most prominent parameters of the user based on the user responses or user behavior and identify a best area by matching the prominent parameters to the environment data 120 to suggest an optimal location for the user. According to the embodiment, the PWM program 110A, 110B may assign a different weight having an associated p-value to each parameter of the user in the user preferences 118. The p-value may then be updated based on the user feedback or behavior. When a value of p is below a predetermined threshold, the PWM program 110A, 110B may determine that the associated parameter is not of an interest to the user.

Then, at 212, the PWM program 110A, 110B determines whether the user is satisfied with the optimal location. According to an example embodiment, the PWM program 110A, 110B may determine whether the user is satisfied with the optimal location by asking the user using a graphical user interface. In another example, the PWM program 110A, 110B may determine user satisfaction based on a time threshold the user spent at the optimal location. For example, if the user spent at the location at least 50% of the overall time the user typically spends in the workplace then the PWM program 110A, 110B may infer that the user is satisfied. If the PWM program 110A, 110B determined the user is satisfied with the optimal location (step 212, “YES” branch), the PWM program 110A, 110B may terminate. If the PWM program 110A, 110B determines that the user is not satisfied with the optimal location (step 212, “NO” branch), the PWM program 110A, 110B may continue to step 214 to update user requirements.

Next, at 214, the PWM program 110A, 110B updates user requirements. According to an example embodiment, the PWM program 110A, 110B may request the user to answer questions using a graphical user interface, such why is the location is not an optimal location. The PWM program 110A, 110B may analyze the user reply using word embedding techniques and update the user requirements accordingly. For example, if the user stated that there are no windows at the location, the PWM program 110A, 110B may update the user preferences that a threshold proximity to a window is required for the user and reevaluate the environment from step 204.

It may be appreciated that FIG. 2 provides only an illustration of one implementation and does not imply any limitations with regard to how different embodiments may be implemented. Many modifications to the depicted environments may be made based on design and implementation requirements. In alternate embodiments, the PWM program 110A, 110B may determine, automatically, the optimal location for the user and guide the user using the geolocation device 122 to the optimal location within the workspace.

FIG. 3 is a block diagram 300 of internal and external components of the mobile device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The mobile device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the personalized workspace management program 110A in the mobile device 102, and the PWM program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the cognitive screen protection program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the personalized workspace management program 110A in the mobile device 102 and the personalized workspace management program 110B in the server 112 can be downloaded to the mobile device 102 and the server 112 from an external computer via a network (for example, the Internet, a local area network or other, wide area network) and respective network adapters or interfaces 336. From the network adapters or interfaces 336, the software program 108 and the personalized workspace management program 110A in the mobile device 102 and the personalized workspace management program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

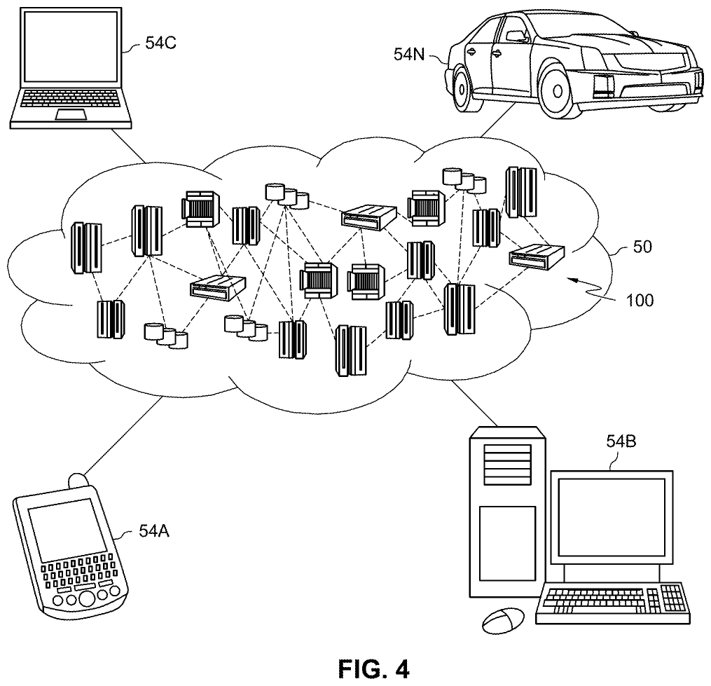

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

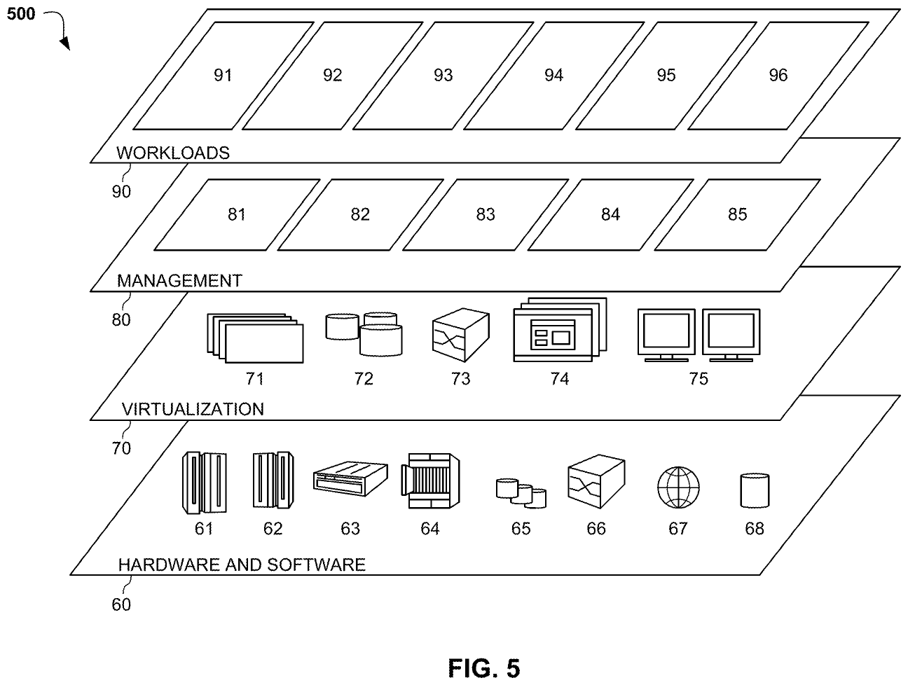

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and personalized workspace management 96. Personalized workspace management 96 may relate to identifying user preferences related to an optimal workspace location and based on monitored biometric and environmental conditions determining the optimal workspace for the user using a reinforcement driven engine.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for personalized workspace management, the method comprising:
generating a profile of a user based on user preferences, wherein the user preferences relate to an optimal user workspace within a workplace;
monitoring biometric conditions of the user and environmental conditions of the workspace;
categorizing a plurality of areas of the workplace based on the environmental conditions; and
identifying a workspace for the user as an area within the plurality of areas most closely aligned with the user preferences and the monitored biometric conditions.

2. The method of claim 1, further comprising:
guiding the user to a geolocation associated with the identified workspace using a geolocation sensor.

3. The method of claim 1, wherein categorizing the plurality of areas is based on a regression prediction model.

4. The method of claim 1, wherein categorizing the plurality of areas is based on a trained neural network.

5. The method of claim 1, wherein determining the optimal user workspace for the user is based on a reinforcement driven engine.

6. The method of claim 1, wherein determining the optimal user workspace for the user further comprises:
identifying prominent parameters from the user preferences is based on a regression prediction model; and
matching the prominent parameters to the environmental conditions to identify the area within the plurality of areas.

7. The method of claim 1, further comprising:
determining a user satisfaction with the identified workspace for the user.

8. A computer system for personalized workspace management, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a profile of a user based on user preferences, wherein the user preferences relate to an optimal user workspace within a workplace;
monitoring biometric conditions of the user and environmental conditions of the workspace;
categorizing a plurality of areas of the workplace based on the environmental conditions; and
identifying a workspace for the user as an area within the plurality of areas most closely aligned with the user preferences and the monitored biometric conditions.

9. The computer system of claim 8, further comprising:
guiding the user to a geolocation associated with the identified workspace using a geolocation sensor.

10. The computer system of claim 8, wherein categorizing the plurality of areas is based on a regression prediction model.

11. The computer system of claim 8, wherein categorizing the plurality of areas is based on a trained neural network.

12. The computer system of claim 8, wherein determining the optimal user workspace for the user is based on a reinforcement driven engine.

13. The computer system of claim 8, wherein determining the optimal user workspace for the user further comprises:
identifying prominent parameters from the user preferences is based on a regression prediction model; and
matching the prominent parameters to the environmental conditions to identify the area within the plurality of areas.

14. The computer system of claim 8, further comprising:
determining a user satisfaction with the identified workspace for the user.

15. A computer program product for personalized workspace management, the computer program product comprising:
one or more computer-readable tangible storage medium and program instructions stored on at least one of the one or more tangible storage medium, the program instructions executable by a processor, the program instructions comprising:
program instructions to generate a profile of a user based on user preferences, wherein the user preferences relate to an optimal user workspace within a workplace;
program instructions to monitor biometric conditions of the user and environmental conditions of the workspace;
program instructions to categorize a plurality of areas of the workplace based on the environmental conditions; and
program instructions to identify a workspace for the user as an area within the plurality of areas most closely aligned with the user preferences and the monitored biometric conditions.

16. The computer program product of claim 15, further comprising:
program instructions to guide the user to a geolocation associated with the identified workspace using a geolocation sensor.

17. The computer program product of claim 15, wherein program instructions to categorize the plurality of areas is based on a regression prediction model.

18. The computer program product of claim 15, wherein program instructions to categorize the plurality of areas is based on a trained neural network.

19. The computer program product of claim 15, wherein program instructions to determine the optimal user workspace for the user is based on a reinforcement driven engine.

20. The computer program product of claim 15, wherein program instructions to determine the optimal user workspace for the user further comprises:
program instructions to identify prominent parameters from the user preferences is based on a regression prediction model; and
program instructions to match the prominent parameters to the environmental conditions to identify the area within the plurality of areas.
